(19) United States
(12) Patent Application Publication
(10) Pub. No.: US 2026/0288969 A1
(43) Pub. Date: Sep. 24, 2026

(54) MULTI-AGENT FRAMEWORK FOR INFORMATION TECHNOLOGY (IT) AUTOMATION AND INCIDENT MANAGEMENT

(71) Applicant: International Business Machines Corporation, Armonk, NY (US)

(72) Inventors: Saurabh Jha, White Plains, NY (US); Ameet Annasaheb Rahane, San Francisco, CA (US); Marc Aaron Palaci-Olgun, Toronto (CA); Raghavendra Kattinakere, Markham (CA); Larisa Shwartz, Greenwich, CT (US); Daby Mousse Sow, White Plains, NY (US); Yu Deng, Yorktown Heights, NY (US); Ruchi Mahindru, Elmsford, NY (US)

(21) Appl. No.: 19/086,200

(22) Filed: Mar. 21, 2025

(51) Int. Cl. G06F 21/57

(52) U.S. Cl. CPC G06F 21/577; G06F 2221/034

(57) ABSTRACT

The present disclosure provides a computer-implemented method comprising receiving information regarding an information technology (IT) system, automatically providing context identification information, wherein the context identification information considers both technical metrics and human observations, inputting the information into an artificial intelligence (AI) assistant that analyzes the information, wherein the AI assistant includes multiple AI agents, wherein at least one of the multiple AI agents comprises a large language model (LLM) agent, managing information related to the AI assistant's interactions and decision-making processes, and generating an assessment, from the AI assistant, regarding the IT system. The assessment may comprise a root cause analysis or at least one mitigation step for the IT system.

### BACKGROUND

The present disclosure relates to information technology (IT) automation systems, and more particularly to a multi-agent framework for efficient IT incident management and root cause analysis using artificial intelligence.

IT systems have become increasingly complex and interconnected, with organizations relying heavily on these systems to support critical business operations. As the scale and complexity of IT infrastructures grow, managing and maintaining them efficiently has become a significant challenge for IT teams.

Traditional approaches to IT management often involve manual processes and reactive troubleshooting, which can be time-consuming and prone to human error. This can lead to prolonged system downtime, reduced productivity, and potential financial losses for businesses. Additionally, the sheer volume of data generated by modern IT systems makes it difficult for human operators to quickly identify and resolve issues.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a computer-implemented method is provided. The method includes receiving information regarding IT system and inputting the information into an artificial intelligence (AI) assistant that analyzes the information, wherein the AI assistant includes multiple AI agents, wherein at least one of the multiple AI agents comprises a large language model (LLM) agent. The method further includes, in response to the inputting, receiving as output from the AI assistant at least one assessment regarding the IT system.

According to other aspects of the present disclosure, the method may include one or more of the following features. The assessment may comprise a root cause analysis. The assessment may comprise at least one mitigation step for the IT system, the at least one mitigation step responding to an incident represented by the information. The AI assistant may comprise a Q-learning-based main planner agent which invokes others of the multiple AI agents.

The foregoing general description of the illustrative embodiments and the following detailed description thereof are merely exemplary aspects of the teachings of this disclosure and are not restrictive.

### BRIEF DESCRIPTION OF FIGURES

FIG. 1 depicts a diagram graphically illustrating the hardware components of a computing environment 100, such as multi-agent IT computing environment 200, and a cloud computing environment, in accordance with an embodiment of the present invention.

FIG. 2 illustrates multi-agent IT computing environment 200, in accordance with an embodiment of the present invention.

FIG. 3 is a flowchart illustrating the operation of multi-agent IT framework program 220 of FIG. 2, in accordance with an embodiment of the present invention.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a multi-agent framework for IT automation and incident management. This framework may be designed to handle a wide range of IT automation use cases, providing a versatile solution for various operational challenges in information technology environments.

Automation has emerged as a potential solution to address challenges in IT management. By leveraging automated tools and processes, organizations can streamline routine tasks, improve efficiency, and reduce the likelihood of human error. However, implementing effective automation in complex IT environments remains a complex undertaking.

One area where automation can have a substantial impact is in incident management and root cause analysis. When IT issues arise, quickly identifying the source of the problem and implementing a resolution is crucial. Traditional methods of incident management often rely on the expertise of individual IT professionals, which can lead to inconsistent results and longer resolution times.

AI and machine learning technologies have shown promise in enhancing IT automation capabilities. These technologies can analyze large volumes of data, identify patterns, and make predictions or recommendations based on historical information. However, integrating AI effectively into IT management processes presents its own set of challenges, including ensuring the accuracy and reliability of AI-driven decisions.

As organizations continue to grapple with the complexities of modern IT environments, there is a growing need for more sophisticated and intelligent approaches to IT automation and incident management. Developing systems that can effectively leverage AI and automation while maintaining human oversight and expertise remains an active area of research and development in the field of IT management.

Hereinafter, exemplary embodiments of the present invention will be described in detail with reference to the attached drawings.

The present invention is not limited to the exemplary embodiments below but may be implemented with various modifications within the scope of the present invention. In addition, the drawings used herein are for purposes of illustration and may not show actual dimensions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

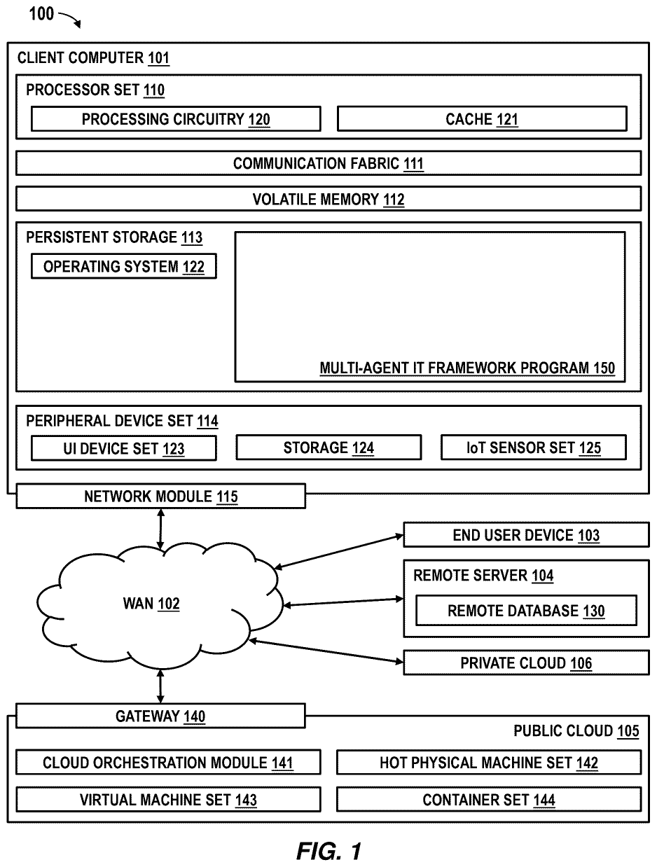

FIG. 1 depicts a diagram graphically illustrating the hardware components of a computing environment 100, such as multi-agent IT computing environment 200, and a cloud computing environment in accordance with an embodiment of the present invention.

Computing environment 100 contains an example of an environment for the execution of at least some of the computer code involved in performing the inventive methods, such as multi-agent IT framework program code 150. In addition to the multi-agent IT framework program code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and multi-agent IT framework program code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in multi-agent IT framework program code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and rewriting of data. Some familiar forms of persistent storage include magnetic disks and solid-state storage devices. Operating system 122 may take several forms, such as various known proprietary operating systems or open-source Portable Operating System Interface type operating systems that employ a kernel. The code included in multi-agent IT framework program code 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

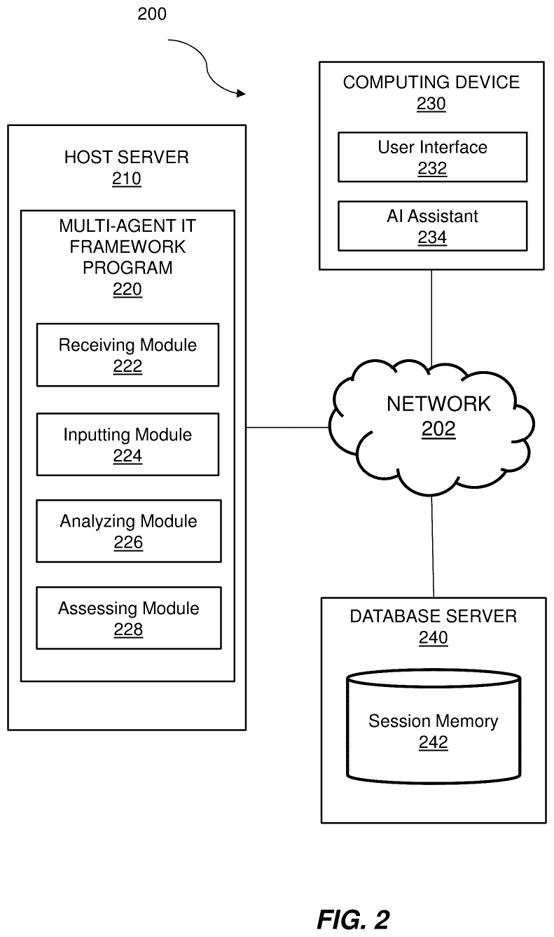

FIG. 2 illustrates multi-agent IT computing environment 200, in accordance with an embodiment of the present invention. Multi-agent IT computing environment 200 includes host server 210, computing device 230, and database server 240, all connected via network 202. The setup in FIG. 2 represents an example embodiment configuration for the present invention and is not limited to the depicted setup to derive benefit from the present invention.

In an exemplary embodiment, host server 210 includes multi-agent IT framework program 220. In various embodiments, host server 210 may be a laptop computer, tablet computer, netbook computer, personal computer (PC), a desktop computer, a personal digital assistant (PDA), a smart phone, or any programmable electronic device capable of communicating with computing device 230 and database server 240 via network 202. Host server 210 may include internal and external hardware components, as depicted, and described in further detail with reference to FIG. 1. In other embodiments, host server 210 may be implemented in a cloud computing environment, as further described in relation to FIG. 1. Host server 210 may also have wireless connectivity capabilities allowing it to communicate with user computing device 230, database server 240, and other computers or servers over network 202.

With continued reference to FIG. 2, computing device 230 includes user interface 232 and AI assistant 234. In various embodiments, computing device 230 may be a laptop computer, tablet computer, netbook computer, personal computer (PC), a desktop computer, a personal digital assistant (PDA), a smart phone, a server, a wearable device, or any programmable electronic device capable of communicating with host server 210 and database server 240 via network 202. Computing device 230 may include internal and external hardware components, as depicted, and described in further detail with reference to FIG. 1. In other embodiments, computing device 230 may be implemented in a cloud computing environment, as described in relation to FIG. 1. Computing device 230 may also have wireless connectivity capabilities allowing it to communicate with host server 210, database server 240, and other computers or servers over network 202.

In exemplary embodiments, computing device 230 includes user interface 232, which may be a computer program that allows a user to interact with user computing device 230 and other connected devices via network 202. For example, user interface 232 may be a graphical user interface (GUI). In addition to comprising a computer program, user interface 232 may be connectively coupled to hardware components, such as those depicted in FIG. 1, for sending and receiving data. In an exemplary embodiment, user interface 232 may be a web browser, however in other embodiments user interface 232 may be a different program capable of receiving user interaction and communicating with other devices, such as host server 210, in a single user or multi-user computing environment.

In exemplary embodiments, user interface 232 may be a touch screen display, a visual display, a remote operated display, or a display that receives input from a physical keyboard or touchpad. In alternative embodiments, user interface 232 may be operated via voice commands or by any other means known to one of ordinary skill in the art.

In exemplary embodiments, user computing device 230 includes AI assistant 234, which may be a software program capable of being run on a user computing device, such as computing device 230.

In exemplary embodiments, AI assistant 234 is a software system comprising multiple AI agents designed to analyze information related to an IT system. The AI assistant 234 includes at least one LLM agent and is capable of providing assessments regarding the IT system, such as root cause analyses and mitigation steps. The AI assistant 234 may incorporate a Q-learning-based main planner agent that coordinates the actions of other AI agents, utilizing techniques such as LLMs, planning domain definition language (PDDL), and historical execution data to generate and execute plans for addressing IT incidents and automation tasks.

In exemplary embodiments, database server 240 includes session memory 242. In various embodiments, database server 240 may be a laptop computer, tablet computer, netbook computer, personal computer (PC), a desktop computer, a personal digital assistant (PDA), a smart phone, a server, or any programmable electronic device capable of communicating with host server 210 and computing device 230 via network 202. Database server 240 may include internal and external hardware components, as depicted and described in further detail with reference to FIG. 1. In other embodiments, database server 240 may be implemented in a cloud computing environment, as described in relation to FIG. 1. Database server 240 may also have wireless connectivity capabilities allowing it to communicate with host server 210, computing device 230, and other computers or servers over network 202.

In exemplary embodiments, the AI assistant 234 may include a session memory 242 component. The session memory 242 component may be designed to store and manage information related to the AI assistant's 234 interactions and decision-making processes.

The session memory 242 component may comprise two distinct parts: experiential memory and hippocampus memory. These two memory types may serve different purposes and may be utilized in different ways by the AI assistant 234.

Experiential memory may be responsible for storing all interactions between the planner agent and the various tools or other agents within the AI assistant 234. This may include queries, responses, intermediate results, and any other data generated during the course of the AI assistant's 234 operations. Experiential memory may serve as a comprehensive record of the AI assistant's 234 activities, potentially allowing for later analysis or review of the decision-making process.

Hippocampus memory, on the other hand, may be designed to store only validated or correct interactions. In some cases, an evaluation process may be used to judge whether a particular experience or interaction is critical to future decision-making. If an interaction is deemed critical, it may be committed to the hippocampus memory.

The process of committing information to hippocampus memory may involve a validation step. This validation may be performed by specialized components within the AI assistant 234, or it may involve input from human operators or domain experts. The validation process may help ensure that only high-quality, reliable information is stored in the hippocampus memory for future use.

In some cases, the AI assistant 234 may use the information stored in the hippocampus memory to inform future decisions or actions. By referring to previously validated interactions, the AI assistant 234 may be able to make more informed choices or avoid repeating past mistakes.

The session memory 242 component may also include mechanisms for managing the size and content of both the experiential and hippocampus memories. This may involve processes for prioritizing certain types of information, removing outdated or less relevant data, or compressing stored information to optimize memory usage.

By maintaining both a comprehensive experiential memory and a curated hippocampus memory, the session memory 242 component may enable the AI assistant 234 to learn from past experiences while focusing on the most critical and validated information for future decision-making.

While session memory 242 is depicted as being stored on database server 240, in other embodiments, session memory 242 may be stored on computing device 230, host server 210, multi-agent IT framework program 220, or any other device or database connected via network 202, as a separate database. In alternative embodiments, session memory 242 may be comprised of a cluster or plurality of computing devices, working together, or working separately.

With continued reference to FIG. 2, host server 210 includes multi-agent IT framework program 220. Host server 210 may be a laptop computer, tablet computer, netbook computer, personal computer (PC), a desktop computer, a personal digital assistant (PDA), a smart phone, or any programmable electronic device capable of communicating with computing device 230 and database server 240, via network 202.

With continued reference to FIG. 2, multi-agent IT framework program 220, in an exemplary embodiment, may be a computer application on host server 210 that contains instruction sets, executable by a processor. The instruction sets may be described using a set of functional modules. In exemplary embodiments, multi-agent IT framework program 220 may receive input from computing device 230 and database server 240 over network 202. In alternative embodiments, multi-agent IT framework program 220 may be a computer application on user computing device 230, or a standalone program on a separate electronic device.

In exemplary embodiments, multi-agent IT framework program 220 may be capable of addressing compliance-related tasks. These tasks may include vulnerability assessments, compliance evaluations, and reporting functions. Multi-agent IT framework program 220 may also assist with audit-related activities, such as responding to information document requests and maintaining audit trails.

Multi-agent IT framework program 220 may additionally support financial operations (FinOps) use cases. In some implementations, this may involve managing cloud and infrastructure costs, as well as labor expenses. The framework may aid in budgeting, planning, and forecasting activities. In certain cases, the system may generate cost overrun alerts and assist in balancing service level agreements (SLAs) and service level objectives (SLOs) automatically.

Incident management may be another key area addressed by multi-agent IT framework program 220. This may encompass root cause analytics, tracking of chronological snapshots and changes, alerting mechanisms, and integration with ticketing and collaboration processes. The framework may also incorporate anomaly detection capabilities and provide remediation recommendations.

Furthermore, multi-agent IT framework program 220 may extend its functionality to resource management use cases. In some implementations, this may include tasks such as constraint-aware safe scale-down operations, helping to optimize resource allocation and utilization.

In alternative embodiments, multi-agent IT framework program 220 may be capable of addressing compliance-related tasks. These tasks may include vulnerability assessments, compliance evaluations, and reporting functions. The framework may also assist with audit-related activities, such as responding to information document requests and maintaining audit trails.

In alternative embodiments, incident management may be another key area addressed by multi-agent IT framework program 220. This may encompass root cause analytics, tracking of chronological snapshots and changes, alerting mechanisms, and integration with ticketing and collaboration processes. Multi-agent IT framework program 220 may also incorporate anomaly detection capabilities and provide remediation recommendations.

Furthermore, multi-agent IT framework program 220 may extend its functionality to resource management use cases. In some implementations, this may include tasks such as constraint-aware safe scale-down operations, helping to optimize resource allocation and utilization.

By encompassing these diverse use cases, multi-agent IT framework program 220 offers a comprehensive approach to IT automation, potentially enhancing operational efficiency and effectiveness across various aspects of IT management.

With continued reference to FIG. 2, the functional modules of multi-agent IT framework program 220 include receiving module 222, inputting module 224, analyzing module 226, and assessing module 228.

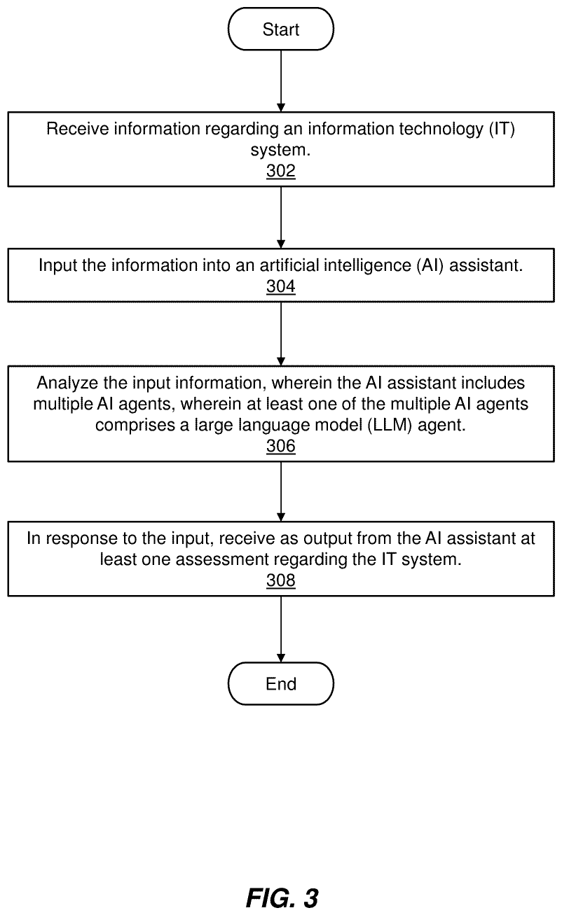

FIG. 3 is a flowchart illustrating the operation of multi-agent IT framework program 220 of FIG. 2, in accordance with embodiments of the present disclosure.

With reference to FIGS. 2 and 3, receiving module 222 includes a set of programming instructions, in multi-agent IT framework program 220, to receive information regarding an IT system (step 302). The set of programming instructions is executable by a processor.

In exemplary embodiments, receiving module 222 obtains data related to an IT system, wherein the data includes system logs, performance metrics, configuration details, network traffic information, and/or user reports.

The data obtained from the IT system may encompass a wide range of information sources crucial for comprehensive analysis and troubleshooting. System logs provide detailed records of events, errors, and activities within the IT infrastructure, offering valuable insights into system behavior and potential issues. Performance metrics include quantitative measurements of various system components, such as CPU usage, memory utilization, disk I/O, and network throughput, enabling the AI assistant 234 to assess system health and identify performance bottlenecks. Configuration details encompass information about system settings, software versions, and hardware specifications, which are essential for understanding the IT environment's structure and potential compatibility issues. Network traffic information includes data about communication patterns, protocols, and data flow within the IT infrastructure, helping to identify network-related problems or security concerns. User reports may contain qualitative information from end-users or IT staff about observed issues, error messages, or unusual system behavior, providing context that may not be captured by automated monitoring systems. This diverse set of data sources enables the AI assistant 234 to perform a holistic analysis of the IT system, considering both technical metrics and human observations to generate accurate assessments and recommendations.

With continued reference to FIGS. 2 and 3, providing module 224 includes a set of programming instructions, in multi-agent IT framework program 220, to automatically provide context identification information, wherein the context identification information considers both technical metrics and human observations (step 304). The set of programming instructions is executable by a processor.

With continued reference to FIGS. 2 and 3, inputting module 226 includes a set of programming instructions, in multi-agent IT framework program 220, to input the information into an AI assistant that analyzes the information, wherein the AI assistant includes multiple AI agents, wherein at least one of the multiple AI agents comprises a large language model (LLM) agent, and wherein the AI assistant comprises a session memory component (step 306). The set of programming instructions is executable by a processor.

In exemplary embodiments, the AI assistant 234 may include a Q-learning-based main planner agent. The Q-learning-based main planner agent may be responsible for executing sequences of actions by invoking other agents within the AI assistant 234.

For example, when faced with a network latency issue, the Q-learning-based main planner agent might first invoke a context discovery agent to gather relevant system metrics, then call upon a specialized tool agent to analyze network traffic patterns and finally engage an LLM agent to interpret the results and suggest potential solutions. This coordinated sequence of actions allows the AI assistant 234 to leverage the strengths of different agents in addressing complex IT challenges.

The Q-learning-based main planner agent employs a sophisticated approach to decision-making by integrating multiple advanced technologies. Large language models (LLMs), which are deep learning algorithms trained on vasts amount of text data, provide the agent with natural language understanding and generation capabilities. This allows the agent to interpret complex IT system descriptions and generate human-readable plans.

Planning domain definition language (PDDL), a standardized AI planning language, enables the agent to formally represent the IT system's state, actions, and goals. This structured representation facilitates the creation of logical and efficient plans for addressing IT incidents or automation tasks.

Historical execution data serves as a valuable resource for the agent, allowing it to learn from past experiences and outcomes. By analyzing previous plans, their effectiveness, and the results they achieved, the agent can refine its decision-making process over time.

The combination of these three elements-LLMs, PDDL, and historical data enables the Q-learning-based main planner agent to make highly informed decisions when determining the optimal next step in a plan. This hybrid approach leverages both data-driven insights and predefined planning structures, striking a balance between flexibility and consistency in IT automation and incident management.

For example, when faced with a network performance issue, the agent might use its LLM capabilities to understand the nuances of the reported problem, apply PDDL to formulate potential action sequences, and consult historical data to identify similar past incidents and their successful resolutions. This comprehensive analysis allows the agent to propose a well-reasoned and contextually appropriate next step, such as initiating a specific diagnostic tool or escalating the issue to a particular team.

By utilizing this multi-faceted approach, the Q-learning-based main planner agent can adapt to a wide range of IT scenarios while maintaining a structured and logical planning process. This methodology enhances the AI assistant's ability to handle complex IT automation tasks and incident management challenges effectively.

In some implementations, the Q-learning-based main planner agent may maintain a Q-table, which represents the expected utility of taking a particular action in a given state. The agent may update this Q-table based on the outcomes of its actions, allowing it to improve its decision-making over time.

When faced with a new situation or task, the Q-learning-based main planner agent may consult its Q-table to determine the action with the highest expected utility.

In exemplary embodiments, the Q-learning-based main planner agent may interact with other specialized agents within AI assistant 234. For example, it may invoke a context discovery agent to gather relevant information about the current state of the IT system. It may also call upon specialized tool agents to perform specific tasks or analyses.

With continued reference to FIGS. 2 and 3, analyzing module 227 analyzes the information via AI assistant 234, wherein AI assistant 234 includes multiple AI agents, wherein at least one of the multiple AI agents comprises a large language model (LLM) agent, and wherein the AI assistant comprises a session memory component (step 308). The set of programming instructions is executable by a processor.

By combining Q-learning techniques with LLMs, PDDL, and historical data, the main planner agent may be able to generate flexible and effective plans for addressing various IT automation tasks and incidents.

In alternative embodiments, the AI assistant 234 may include a Q-learning-based task decomposition planning agent. This agent may be responsible for breaking down complex tasks or steps in the overall plan into smaller, more manageable subtasks that can be executed by chaining multiple tools together.

The Q-learning-based task decomposition planning agent may utilize reinforcement learning techniques to learn optimal ways of decomposing tasks over time. In some implementations, the agent may maintain a Q-table that represents the expected utility of different decomposition strategies for various types of tasks.

When presented with a task or step from the main planner, the task decomposition planning agent may first analyze the task to identify its key components and requirements. Based on this analysis, the agent may consult its Q-table to determine the most promising decomposition strategy.

In some cases, the decomposition process may involve identifying a sequence of specialized tools that need to be invoked to complete the task. For example, if the task involves analyzing system performance, the agent might decompose this into subtasks such as gathering relevant metrics, detecting anomalies, and generating a performance report.

The task decomposition planning agent may also consider dependencies between subtasks when creating its decomposition plan. This may ensure that subtasks are executed in an order that maintains logical consistency and efficiency.

As the agent executes its decomposition strategies and observes the outcomes, it may update its Q-table to reflect the effectiveness of different approaches. This continuous learning process may allow the agent to improve its task decomposition abilities over time, potentially leading to more efficient and effective execution of complex IT automation tasks.

In some implementations, the task decomposition planning agent may interact with other components of AI assistant 234, such as the context discovery agent or specialized tool agents, to gather additional information or validate its decomposition strategies. This collaborative approach may help ensure that the decomposed subtasks are well-aligned with the current state of the IT system and the available resources.

The Q-learning-based task decomposition planning agent may also incorporate feedback mechanisms to evaluate the success of its decompositions. This feedback may come from the outcomes of executed subtasks, the overall completion of the main task, or input from human operators. By incorporating this feedback into its learning process, the agent may continually refine its decomposition strategies to better meet the needs of the IT automation system.

In exemplary embodiments, AI assistant 234 may include a context discovery agent. The context discovery agent may be responsible for dynamically discovering necessary context from two primary sources: large volumes of observability data and IT operations (ITOps) knowledge bases.

The context discovery agent may employ taxonomy-guided and topology-guided context management methods to process and utilize the data sources effectively. Taxonomy-guided context management may

In some cases, the AI assistant 234 may include a reflection agent. The reflection agent may be responsible for monitoring and evaluating the performance of other agents within the AI assistant, as well as detecting potential issues in their operation.

The reflection agent may employ various techniques to detect loops in the execution of other agents. In some implementations, the reflection agent may analyze the sequence of actions taken by other agents, looking for repetitive patterns that may indicate a loop. The reflection agent may also maintain a history of states and actions, comparing current states to previous ones to identify potential cyclical behavior.

In addition to loop detection, the reflection agent may be capable of identifying hangs or stalls in the system's operation. This may involve monitoring the progress of tasks and subtasks, tracking the time spent on each action, and comparing these durations to expected or historical execution times. If an action or sequence of actions takes significantly longer than anticipated, the reflection agent may flag this as a potential hang.

The reflection agent may also perform verification and validation of outputs produced by other agents using domain constraints. In some cases, this may involve checking that the outputs conform to predefined rules or expectations specific to the IT domain. For example, the reflection agent may verify that suggested actions do not violate security policies or that proposed configurations are compatible with the existing IT infrastructure.

To facilitate this verification and validation process, the reflection agent may maintain or have access to a knowledge base of domain constraints. This knowledge base may include information about system architecture, operational policies, and best practices in IT management. The reflection agent may use this information to assess the validity and appropriateness of actions and outputs generated by other agents in the AI assistant.

In some implementations, the reflection agent may also incorporate self-monitoring features. These features may include additional layers of hang detection and loop detection applied to the reflection agent's own operations. This self-monitoring capability may help ensure the reliability and effectiveness of the reflection agent itself.

The reflection agent may also implement guard-rails to prevent potentially harmful or inappropriate actions. These guard-rails may be based on predefined rules or learned from historical data and expert input. In some cases, the guard-rails may prevent actions that could compromise system stability, violate compliance requirements, or exceed authorized resource usage limits.

When the reflection agent detects issues such as loops, hangs, or outputs that fail validation, it may take various actions. These actions may include alerting other agents or human operators, suggesting alternative courses of action, or initiating predefined recovery procedures. In some implementations, the reflection agent may have the authority to pause or terminate problematic processes to prevent potential damage or resource waste.

The reflection agent may also provide feedback to other agents in the AI assistant, helping them improve their performance over time. This feedback may be based on the outcomes of the reflection agent's monitoring and validation processes, potentially leading to more efficient and effective operation of the entire AI assistant system.

With continued reference to FIGS. 2 and 3, managing module 228 manages, by the session memory component, information related to the AI assistant's interactions and decision-making processes (step 310). The set of programming instructions is executable by a processor.

With continued reference to FIGS. 2 and 3, generating module 229 generates an assessment, from the AI assistant 234, regarding the IT system (step 312). The set of programming instructions is executable by a processor.

In exemplary embodiments, generating module 229 may include a set of specialized tools designed to support various aspects of IT automation and incident management. These specialized tools may provide specific functionalities that enhance the capabilities of AI assistant 234 and its agents.

One such tool may be a Graph Explorer. The Graph Explorer may be a specialized tool for gathering and traversing infrastructure and application topology and taxonomy graphs. This tool may allow AI assistant 234 to understand the relationships between different components of the IT system, potentially aiding in root cause analysis and impact assessment.

Another specialized tool may be a Trace Explorer. The Trace Explorer may be designed for gathering and understanding trace data, as well as supporting queries over traces. This tool may help AI assistant 234 analyze the flow of requests through the system, potentially identifying bottlenecks or errors in the process.

A Metric Explorer may also be included in the set of specialized tools. The Metric Explorer may be responsible for gathering and understanding metrics related to the IT system's performance. This tool may provide AI assistant 234 with quantitative data that can be used to assess system health and identify anomalies.

In some cases, the framework may include a Log Explorer. The Log Explorer may be a specialized tool for gathering and understanding log data from various components of the IT system. This tool may help AI assistant 234 extract relevant information from system logs, potentially aiding in troubleshooting and incident analysis.

The set of specialized tools may also include an Anomaly Detection and Forecasting tool. This tool may be designed to perform anomaly detection on multivariate metrics and provide explanations for detected anomalies. Additionally, it may offer forecasting capabilities, potentially helping AI assistant 234 predict and prevent future issues.

A Causal Calculus tool may be included to create causal graphs when trace data is missing or incomplete. This tool may help AI assistant 234 understand cause-and-effect relationships within the IT system, even in scenarios where full observability is not available.

The framework may also incorporate an Environment Cmd Execution tool. This specialized tool may allow AI assistant 234 to interact directly with the IT environment, potentially executing commands or scripts as part of incident resolution or system management tasks.

An Output Explanation Tool may be included in the set of specialized tools. This tool may be responsible for parsing and understanding the outputs of other tools within the framework. It may help AI assistant 234 interpret and contextualize the results of various analyses and operations.

In some cases, the framework may include a Workload Consolidation Tool. This specialized tool may suggest which applications or resources can be shut down or consolidated, potentially aiding in resource optimization and cost management.

A Business Criticality Value (BCV) Explorer tool may be part of the specialized toolset. This tool may be designed to identify the business criticality value of various components or services within the IT system. It may help AI assistant 234 prioritize actions and allocate resources based on the relative importance of different system elements.

As used herein, the BCV may be determined based on factors such as the component's impact on business operations, revenue generation, customer satisfaction, regulatory compliance, or other key performance indicators. In the context of the multi-agent framework for IT automation and incident management, the BCV is utilized to prioritize actions, allocate resources, and inform decision-making processes to ensure that the most critical elements of the IT system receive appropriate attention and support.

The framework may also include an Evidence Checker. This specialized tool may check if evidence, which may be managed by validation components, already exists for a given scenario or incident. It may help prevent redundant analysis and ensure that existing information is leveraged effectively.

A Policy Checker may be included in the set of specialized tools. This tool may be responsible for checking if policies for audits or compliance assessments already exist. It may help ensure that AI assistant's 234 actions and recommendations align with established organizational policies and regulatory requirements.

Lastly, the framework may incorporate a Validation Checker. This specialized tool may check if validation tools already exist for rule assessment. It may help ensure the integrity and reliability of AI assistant's 234 analyses and recommendations by verifying that appropriate validation mechanisms are in place.

These specialized tools may work in conjunction with AI assistant 234 and its agents, providing specific functionalities that enhance the overall capabilities of the multi-agent framework for IT automation and incident management.

In alternative embodiments, the multi-agent framework may utilize a system for generating synthetic data to support training and improvement of AI assistant 234 and its components. This synthetic data generation process may involve simulating various IT scenarios, incidents, and automation tasks to create a diverse dataset for training and evaluation purposes.

The synthetic data generation system may work in conjunction with other components of multi-agent IT framework program 220 to create realistic and relevant data. For example, the system may utilize information from the specialized tools, such as the Graph Explorer and Metric Explorer, to generate synthetic topology graphs and performance metrics that closely resemble real-world IT environments.

In some implementations, the synthetic data generation system may incorporate input from subject matter experts (SMEs) or site reliability engineers (SREs) to ensure the generated data accurately represents common IT challenges and scenarios. These experts may provide guidance on the types of incidents, system behaviors, and automation tasks that should be simulated.

The synthetic data generation process may also include the creation of simulated user interactions, system logs, and incident reports. This may help train the AI assistant to handle a wide range of input formats and information sources that may be encountered in real-world IT environments.

In alternative embodiments, the synthetic data generation system may create intentional errors or anomalies within the generated data. This may help train AI assistant 234 and its components, such as the anomaly detection and forecasting tool, to identify and respond to unusual or problematic situations.

The generated synthetic data may be used to train and fine-tune various components of multi-agent IT framework program 220. For example, the Q-learning-based main planner agent may use synthetic data to improve its decision-making processes and expand its knowledge base. Similarly, the context discovery agent may utilize synthetic data to enhance its ability to identify relevant information from large volumes of observability data.

In some implementations, the synthetic data generation system may work in an iterative manner, continuously generating new data based on the performance and feedback of AI assistant 234. This iterative process may help identify areas where AI assistant 234 requires additional training or improvement, allowing for targeted data generation to address specific weaknesses or gaps in the system's capabilities.

The synthetic data generation system may also incorporate feedback mechanisms to evaluate the quality and relevance of the generated data. This may involve comparing AI assistant's 234 performance on synthetic data to its performance on real-world data, and adjusting the data generation process accordingly.

By leveraging synthetic data generation, the multi-agent framework may be able to continuously improve its performance and adaptability, even in scenarios where real-world training data may be limited or difficult to obtain. This approach may help ensure that AI assistant 234 remains effective and up-to-date in addressing evolving IT automation and incident management challenges.

A number of implementations have been described. Nevertheless, it will be understood that various modifications may be made without departing from the spirit and scope of the disclosure.

1. A computer-implemented method comprising:
receiving information regarding an information technology (IT) system;
automatically providing context identification information, wherein the context identification information considers both technical metrics and human observations;
inputting the information into an artificial intelligence (AI) assistant that analyzes the information, wherein the AI assistant includes multiple AI agents, wherein at least one of the multiple AI agents comprises a large language model (LLM) agent, and wherein the AI assistant comprises a session memory component;
managing, by the session memory component, information related to interactions and decision-making processes of the AI assistant; and
generating an assessment, from the AI assistant, regarding the IT system.

2. The computer-implemented method of claim 1, wherein the assessment comprises a root cause analysis.

3. The computer-implemented method of claim 1, wherein the assessment comprises at least one mitigation step for the IT system, the at least one mitigation step responding to an incident represented by the information.

4. The computer-implemented method of claim 1, wherein the AI assistant comprises a Q-learning-based main planner agent which invokes others of the multiple AI agents.

5. The computer-implemented method of claim 4, wherein the Q-learning-based main planner agent uses LLMs, planning domain definition language (PDDL), and historical executions to generate the assessment.

6. The computer-implemented method of claim 5, wherein the Q-learning-based main planner agent defines a goal state using application and system topology to identify and mitigate root causes.

7. The computer-implemented method of claim 1, wherein the AI assistant further comprises a context discovery agent that dynamically discovers necessary context from observability data and IT operations knowledge bases.

8. A system comprising:
a processor; and
a memory storing instructions that, when executed by the processor, cause the system to:
receive information regarding an information technology (IT) system;
automatically provide context identification information, wherein the context identification information considers both technical metrics and human observations;
input the information into an artificial intelligence (AI) assistant that analyzes the information, wherein the AI assistant includes multiple AI agents, wherein at least one of the multiple AI agents comprises a large language model (LLM) agent, and wherein the AI assistant comprises a session memory component;
manage, by the session memory component, information related to interactions and decision-making processes of the AI assistant; and
generate an assessment, from the AI assistant, regarding the IT system.

9. The system of claim 8, wherein the assessment comprises a root cause analysis of an incident in the IT system.

10. The system of claim 8, wherein the assessment comprises at least one mitigation step for addressing an incident in the IT system.

11. The system of claim 8, wherein the AI assistant comprises a Q-learning-based main planner agent which invokes others of the multiple AI agents.

12. The system of claim 11, wherein the Q-learning-based main planner agent uses LLMs, planning domain definition language (PDDL), and historical executions to generate the assessment.

13. The system of claim 12, wherein the Q-learning-based main planner agent defines a goal state using application and system topology to identify and mitigate root causes.

14. The system of claim 8, wherein the AI assistant further comprises a context discovery agent that dynamically discovers necessary context from observability data and IT operations knowledge bases.

15. A computer program product comprising a non-transitory computer-readable storage medium storing instructions that, when executed by a processor, cause the processor to perform operations comprising:
receiving information regarding an information technology (IT) system;
automatically providing context identification information, wherein the context identification information considers both technical metrics and human observations;
inputting the information into an artificial intelligence (AI) assistant that analyzes the information, wherein the AI assistant includes multiple AI agents, wherein at least one of the multiple AI agents comprises a large language model (LLM) agent, and wherein the AI assistant comprises a session memory component;
managing, by the session memory component, information related to interactions and decision-making processes of the AI assistant; and
generating an assessment, from the AI assistant, regarding the IT system.

16. The computer program product of claim 15, wherein the assessment comprises a root cause analysis of an incident in the IT system.

17. The computer program product of claim 15, wherein the assessment comprises at least one mitigation step for addressing an incident in the IT system.

18. The computer program product of claim 15, wherein the AI assistant comprises a Q-learning-based main planner agent which invokes others of the multiple AI agents.

19. The computer program product of claim 18, wherein the Q-learning-based main planner agent uses LLMs, planning domain definition language (PDDL), and historical executions to generate the assessment.

20. The computer program product of claim 19, wherein the Q-learning-based main planner agent defines a goal state using application and system topology to identify and mitigate root causes.
